(19) United States
(12) Patent Application Publication
(10) Pub. No.: US 2025/0048297 A1
(43) Pub. Date: Feb. 6, 2025

(54) APPARATUS AND METHOD FOR A TERMINAL DEVICE AND APPARATUS AND METHOD FOR A NETWORK DEVICE

(71) Applicant: Nokia Technologies Oy, Espoo (FI)

(72) Inventors: Enric JUAN, Aalborg (DK); Jeroen Wigard, Aalborg (DK)

(21) Appl. No.: 18/770,295

(22) Filed: Jul. 11, 2024

(30) Foreign Application Priority Data
Aug. 2, 2023 (FI) 20235861

(51) Int. Cl. H04W 56/00; H04W 48/20; H04W 84/06

(52) U.S. Cl. CPC H04W 56/0045; H04W 48/20; H04W 84/06

(57) ABSTRACT

An apparatus for a terminal device, the apparatus comprising at least one processor, and at least one memory storing instructions that, when executed by the at least one processor, cause the terminal device to: determine first information characterizing a difference between a first timing advance value associated with a first radio cell that is at least temporarily provided to the terminal device by a first device and a second timing advance value associated with a second radio cell that is at least temporarily provided to the terminal device by a second device, and to transmit the first information to a network device associated at least with the first radio cell.

### FIELD OF THE DISCLOSURE

Various example embodiments relate to an apparatus for a terminal device. Further embodiments relate to a method for a terminal device. Further embodiments relate to an apparatus for a network device. Further embodiments relate to a method for a network device.

### BACKGROUND

Communication systems such as, e.g., wireless communication systems may be used for wireless exchange of information between two or more entities, e.g., comprising one or more terminal devices, e.g., user equipment (UE), and one or more network devices such as, e.g., base stations.

Some communication systems may support non-terrestrial devices or networks, wherein, for example, base stations or at least some aspects of their functionality may be deployed on board of, for example, satellites, e.g., satellites in a low earth orbit, LEO. In some conventional approaches, satellite switching is considered which relates t techniques for switching radio coverage of one or more terminal devices from a first satellite to a second satellite.

### SUMMARY

Various embodiments of the disclosure are set out by the independent claims. The exemplary embodiments and features, if any, described in this specification, that do not fall under the scope of the independent claims, are to be interpreted as examples useful for understanding various exemplary embodiments of the disclosure.

Exemplary embodiments relate to an apparatus for a terminal device, the apparatus comprising at least one processor, and at least one memory storing instructions that, when executed by the at least one processor, cause the terminal device to: determine first information characterizing a difference between a first timing advance value associated with a first radio cell that is at least temporarily provided to the terminal device by a first device and a second timing advance value associated with a second radio cell that is at least temporarily provided to the terminal device by a second device, and to transmit the first information to a network device associated at least with the first radio cell. In some embodiments, this facilitates aspects of an operation of, e.g., the terminal device, for example in cases of switching between the first and second devices.

In some embodiments, the first device may be an aerospace device. In some embodiments, the second device may be an aerospace device. In some embodiments, at least one of the first device and the second device may be a terrestrial, e.g., land terrestrial, device.

While the following exemplary description, for purpose of illustration, primarily relates to the first and second devices being exemplarily configured as aerospace devices, the principle according to the embodiments may also be applied, without loss of generality, to other devices and/or other device types than the exemplarily mentioned aerospace devices, namely, terrestrial e.g., devices any combination thereof. Thus, in other words, the principle according to the embodiments is not limited to aerospace devices.

In some embodiments, at least one of the terminal device and/or the network device may adhere to and/or may be based on some accepted (and/or planned) standard, such as, e.g. 3G, 4G, 5G, 6G, or some wireless communication standard.

In some embodiments, the terminal device may be a user equipment (UE).

In some embodiments, the network device may be a base station, e.g., a gNB. In some embodiments, the network device may e.g. be a base station currently serving the terminal device, e.g. via the first radio cell that is at least temporarily provided to the terminal device by the first aerospace device.

In some embodiments, the first radio cell and the second radio cell may be the same cell (e.g., having a same cell identifier, e.g., physical cell identity, PCI), but may, e.g., be provided through the different devices, e.g., aerospace devices.

In some embodiments, the first information comprises at least one of: a) the first timing advance value and the second timing advance value (i.e., both timing advance values), b) the difference between the first timing advance value and the second timing advance value (i.e., a single value characterizing the difference).

However, in some embodiments, it is also possible that the first information may, e.g. only, comprise the second timing advance value.

In some embodiments, each of the first device and the second device may be any one of the following: a) a spacecraft, for example a satellite, b) a high altitude platform system, HAPS, c) a terrestrial device. In some embodiments, timing advance values associated with aerospace devices such as e.g. satellites or HAPS devices, e.g., as seen from a specific terminal device, may differ significantly, so that in some embodiments, the principle according to the embodiments enables to perform an efficient switching between these aerospace devices for the terminal device.

In some embodiments, at least one of the first device and the second device is no aerospace device, but, for example, a terrestrial device. In some embodiments, in such configurations, too, the related timing advance values may differ significantly, so that in some embodiments, the principle according to the embodiments enables to perform an efficient switching between these devices in such configurations, too, for the terminal device.

In some embodiments, the instructions, when executed by the at least one processor, cause the terminal device to perform at least one of: a) determining the first timing advance value, and/or b) determining the second timing advance value, and/or c) determining the first information.

In some embodiments, the instructions, when executed by the at least one processor, cause the terminal device to perform a switching procedure from the first radio cell provided by the first device to the second radio cell provided by the second device, to determine the second timing advance value prior to performing the switching procedure, and to transmit the first information to the network device associated at least with the first radio cell prior to performing the switching procedure. In some embodiments, this enables to optimize a scheduling of resources for the terminal device for the second radio cell, which may, e.g., be used by the terminal device after the switching procedure.

In some embodiments, the instructions, when executed by the at least one processor, cause the terminal device to perform at least one of: a) transmitting second information to the network device, the second information indicating a point in time from which on the second timing advance value may be used by the terminal device (e.g., a point in time the terminal device would like to use, or proposes to use, respectively, the second timing advance value), and/or b) receiving an indication from the network device instructing the terminal device when to use the second timing advance value.

Further exemplary embodiments relate to an apparatus for a terminal device, the apparatus comprising means for causing the terminal device to: determine first information characterizing a difference between a first timing advance value associated with a first radio cell that is at least temporarily provided to the terminal device by a first device and a second timing advance value associated with a second radio cell that is at least temporarily provided to the terminal device by a second device, and to transmit the first information to a network device associated at least with the first radio cell.

In some embodiments, the means for causing the terminal device to determine the first information and to transmit the first information may, e.g., comprise at least one processor, and at least one memory storing instructions that, when executed by the at least one processor, cause the terminal device to perform the aforementioned aspects.

In some embodiments, the means for causing the terminal device to determine the first information and to transmit the first information may, e.g., comprise circuitry configured to perform the aforementioned aspects.

Further exemplary embodiments relate to a terminal device comprising at least one apparatus according to the embodiments.

Further exemplary embodiments relate to a method for a terminal device, comprising: determining first information characterizing a difference between a first timing advance value associated with a first radio cell that is at least temporarily provided to the terminal device by a first device and a second timing advance value associated with a second radio cell that is at least temporarily provided to the terminal device by a second device, sending the first information to a network device associated at least with the first radio cell.

Further exemplary embodiments relate to an apparatus for a network device, the apparatus comprising at least one processor, and at least one memory storing instructions that, when executed by the at least one processor, cause the network device to: receive from a terminal device first information characterizing a difference between a first timing advance value associated with a first radio cell that is at least temporarily provided to the terminal device by a first device and a second timing advance value associated with a second radio cell that is at least temporarily provided to the terminal device by a second device.

In some embodiments, the instructions, when executed by the at least one processor, cause the network device to receive second information indicating a point in time from which on the second timing advance value may be used by the terminal device.

In some embodiments, the instructions, when executed by the at least one processor, cause the network device to transmit an indication to the terminal device instructing the terminal device when to use the second timing advance value.

Further exemplary embodiments relate to an apparatus for a network device, the apparatus comprising means for causing the network device to: receive from a terminal device first information characterizing a difference between a first timing advance value associated with a first radio cell that is at least temporarily provided to the terminal device by a first device and a second timing advance value associated with a second radio cell that is at least temporarily provided to the terminal device by a second device.

In some embodiments, the means for causing the network device to receive the first information may, e.g., comprise at least one processor, and at least one memory storing instructions that, when executed by the at least one processor, cause the network device to perform the aforementioned aspects.

In some embodiments, the means for causing the network device to receive the first information may, e.g., comprise circuitry configured to perform the aforementioned aspects.

Further exemplary embodiments relate to a terminal device comprising at least one apparatus according to the embodiments.

Further exemplary embodiments relate to a network device comprising at least one apparatus according to the embodiments.

Further exemplary embodiments relate to a method for a network device, comprising: receiving from a terminal device first information characterizing a difference between a first timing advance value associated with a first radio cell that is at least temporarily provided to the terminal device by a first device and a second timing advance value associated with a second radio cell that is at least temporarily provided to the terminal device by a second device.

Further exemplary embodiments relate to a device, e.g., a first device, e.g., a first aerospace device, configured to receive from a terminal device, e.g., via a service link, first information characterizing a difference between a first timing advance value associated with a first radio cell that is at least temporarily provided to the terminal device by the, e.g. first, device and a second timing advance value associated with a second radio cell that is at least temporarily provided to the terminal device by a second device, e.g., a second aerospace device, and to transmit the first information, e.g., via a feeder link, to a, for example terrestrial, network device associated at least with the first radio cell.

Further exemplary embodiments relate to a communication system comprising at least one of: a) an apparatus according to the embodiments, and/or b) a terminal device according to the embodiments, and/or c) a network device according to the embodiments, and/or d) a device, e.g., aerospace device, according to the embodiments.

In some embodiments, the communication system may e.g. be a non-terrestrial communication system adhering to and/or based on some accepted standard, such as, e.g., a 5G or 6G standard.

### BRIEF DESCRIPTION OF THE FIGURES

FIG. 1A schematically depicts a simplified block diagram according to some embodiments,

FIG. 1B schematically depicts a simplified block diagram according to some embodiments,

FIG. 2 schematically depicts a simplified block diagram according to some embodiments,

FIG. 3 schematically depicts a simplified flow chart according to some embodiments,

FIG. 4 schematically depicts a simplified block diagram according to some embodiments,

FIG. 5 schematically depicts a simplified flow chart according to some embodiments,

FIG. 6 schematically depicts a simplified flow chart according to some embodiments,

FIG. 7 schematically depicts a simplified flow chart according to some embodiments,

FIG. 8A schematically depicts a simplified block diagram according to some embodiments,

FIG. 8B schematically depicts a simplified block diagram according to some embodiments,

FIG. 9 schematically depicts a simplified flow chart according to some embodiments,

FIG. 10 schematically depicts a simplified signaling diagram according to some embodiments,

FIG. 11 schematically depicts a simplified time diagram according to some embodiments

FIG. 12 schematically depicts a simplified flow chart according to some embodiments.

### DESCRIPTION OF SOME EXEMPLARY EMBODIMENTS

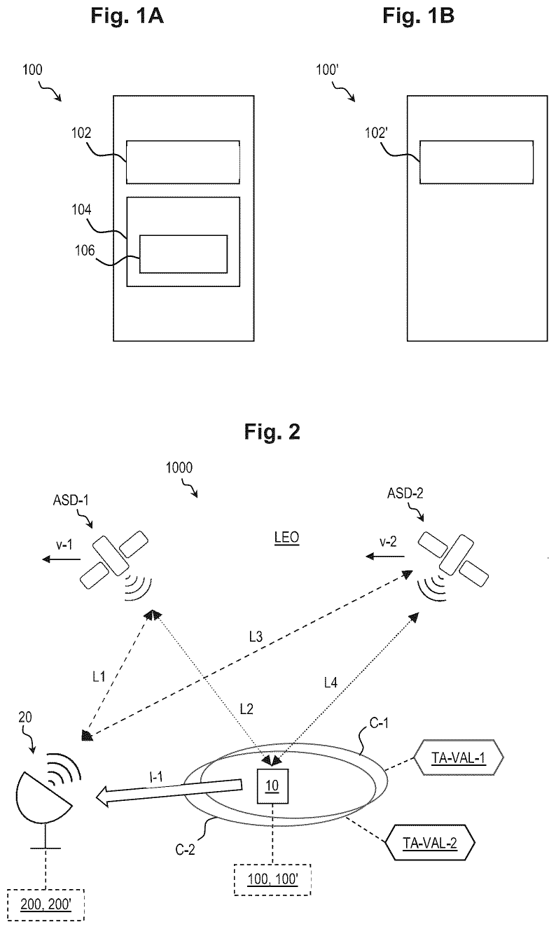

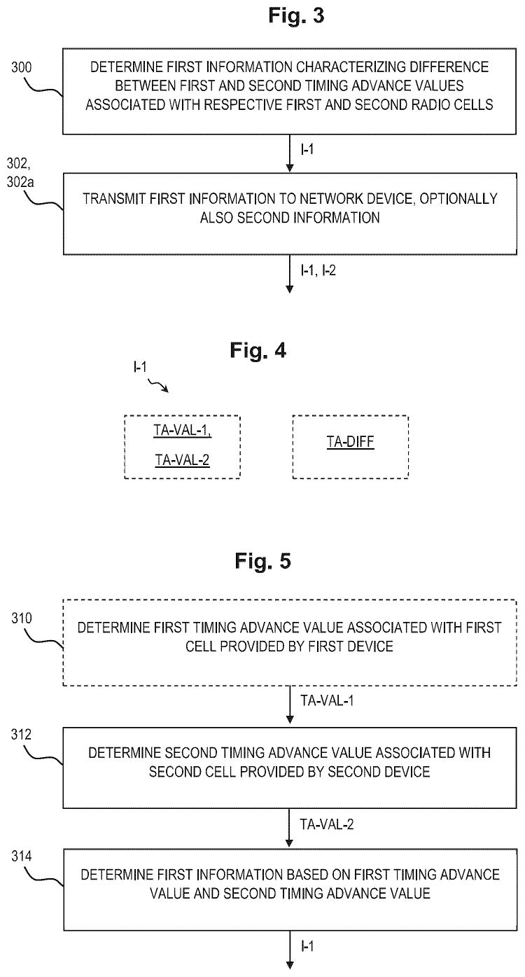

Exemplary embodiments, FIG. 1A, 2, 3, relate to an apparatus 100 (Fig. A) for a terminal device 10 (FIG. 2), the apparatus 100 comprising at least one processor 102, and at least one memory 104 storing instructions 106 that, when executed by the at least one processor 102, cause the terminal device 10 to: determine 300 (FIG. 3) first information I-1 characterizing a difference between a first timing advance value TA-VAL-1 associated with a first radio cell C-1 that is at least temporarily provided to the terminal device 10 by a first device ASD-1 and a second timing advance value TA-VAL-2 associated with a second radio cell C-2 that is at least temporarily provided to the terminal device 10 by a second device ASD-2, and transmit 302 the first information I-1 to a network device 20 associated at least with the first radio cell C-1. In some embodiments, this facilitates aspects of an operation of, e.g., the terminal device 10, for example in cases of switching between the devices ASD-1, ASD-2, or the radio cells C-1, C-2 provided thereby, respectively.

In some embodiments, at least one of the first device ASD-1 and the second device ASD-2 may be a terrestrial, e.g., land terrestrial, device.

In some embodiments, the first device ASD-1 may be an aerospace device, e.g., a first aerospace device ASD-1. In some embodiments, the second device ASD-2 may be an aerospace device, e.g., a second aerospace device ASD-2.

While, for purpose of illustration, the following exemplary description primarily relates to the devices ASD-1, ASD-2 being configured as aerospace devices, the principle according to the embodiments may also be applied, without loss of generality, to other device types than the exemplarily mentioned aerospace devices, namely, e.g., terrestrial devices.

In some embodiments, FIG. 2, at least one of the terminal device 10 and/or the network device 20 may adhere to and/or may be based on some accepted (and/or planned) standard, such as, e.g. 3G, 4G, 5G, 6G, or some other wireless communication standard.

In some embodiments, the terminal device 10 may be a user equipment (UE).

In some embodiments, the network device 20 may be a base station, e.g., a gNB. In some embodiments, the network device 20 may e.g. be a base station currently serving the terminal device 10, e.g. via the first radio cell C-1 that is at least temporarily provided to the terminal device 10 by the first aerospace device ASD-1.

In some embodiments, FIG. 4, the first information I-1 comprises at least one of: a) the first timing advance value TA-VAL-1 and the second timing advance value TA-VAL-2 (i.e., both timing advance values), b) the difference TA-DIFF between the first timing advance value TA-VAL-1 and the second timing advance value TA-VAL-2 (i.e., a single value characterizing the difference TA-DIFF).

In some embodiments, FIG. 2, each of the first aerospace device ASD-1 and the second aerospace device ASD-2 may be any one of the following: a) a spacecraft, for example a satellite, b) a high altitude platform system, HAPS.

In some embodiments, and without loss of generality, both aerospace devices ASD-1, ASD-2 are satellites, as exemplarily depicted by FIG. 2. In view of this, and for the of intelligibility, the further explanations sake exemplarily refer to satellites ASD-1, ASD-2. Note, however, that in some other embodiments, at least one of the aerospace devices ASD-1, ASD-2 may be another type of aerospace device, i.e., different from a satellite.

Returning to FIG. 2, double arrow L1 symbolizes a feeder link between the network device 20 and the first satellite ASD-1, and double arrow L2 symbolizes a corresponding service link between the first satellite ASD-1 and the terminal device 10, e.g. associated with the first radio cell C-1 as provided by the first satellite ASD-1.

Similarly, double arrow L3 symbolizes a feeder link between the network device 20 and the second satellite ASD-2, and double arrow L4 symbolizes a corresponding service link between the second satellite ASD-2 and the terminal device 10, e.g. associated with the second radio cell C-2 as provided by the second satellite ASD-2.

Thus, in some embodiments, the network device 20, e.g. gNB, may, e.g. additionally, comprise a gateway functionality, e.g. operating as an NTN gateway for providing the connectivity symbolizes by the satellite links L1, L3.

In some embodiments, at least one of the satellites ASD-1, ASD-2 may, e.g., be moving in a low earth orbit LEO whereas, for example, the terminal device 10 may be ground-based, i.e. a terrestrial device. Due to different relative positions with respect to the terminal device 10 and/or different velocity vectors v-1, v-2 of the satellites ASD-1, ASD-2, different first and second timing advance values TA-VAL-1, TA-VAL-2 may be associated with, e.g. used and/or required for, communicating via the respective radio cells C-1, C-2 for the terminal device 10.

In some embodiments, these different first and second timing advance values TA-VAL-2, TA-VAL-1, or information characterizing these different first and second timing advance values TA-VAL-1, TA-VAL-2, may be transmitted by the terminal device 10 to the currently serving network device 20, e.g., in the form of the first information I-1.

Note that, while FIG. 2 exemplarily symbolizes the transmission of the first information I-1 from the terminal device 10 to the network device 20, for the sake of clarity and for illustrative purpose only, using a block arrow I-1 directly pointing from the terminal device 10 to the network device 20, in some embodiments, the transmission of the first information I-1 from the terminal device 10 to the network device 20 may, e.g., be performed using the links L1, L2, in a per se known manner, e.g. from the terminal device 10 via the service link L2 to the first satellite ASD-1, and from the first satellite ASD-1 via the feeder link L1 to the network device 20.

As mentioned above, in some embodiments, the timing advance values TA-VAL-1, TA-VAL-2 associated with the aerospace devices AS-1, ASD-2, e.g., as seen from a specific terminal device 10, may differ significantly, so that in some embodiments, the principle according to the embodiments enables to perform an efficient switching between these aerospace devices for the terminal device, e.g. because under knowledge of the first information I-1, in some embodiments, the network device 20 may consider the different timing advance values, e.g. for scheduling resources for the terminal device 10.

In some embodiments, FIG. 5, the instructions 106 (FIG. 1A), when executed by the at least one processor 102, cause the terminal device 10 (FIG. 2) to perform at least one of: a) determining 310 the first timing advance value TA-VAL-1, and/or b) determining 312 the second timing advance value TA-VAL-2, and/or c) determining 314 the first information I-1, e.g., based on the timing advance values TA-VAL-1, TA-VAL-2.

In some embodiments, FIG. 2, the terminal device 10 may determine, e.g. estimate, the first timing advance value TA-VAL-1 based on system information of a currently serving cell, e.g. the first radio cell C-1, as e.g. temporarily provided by the first satellite ASD-1.

In some embodiments, FIG. 2, the terminal device 10 may acquire information associated with the second satellite ASD-2, e.g. satellite system information of the second satellite ASD-2, which, in some embodiments, is e.g. possible in situations where the radio cell C-2 as provided by the second satellite ASD-2 also covers a position of the terminal device 10, as exemplarily depicted by FIG. 2.

In some embodiments, FIG. 2, the terminal device 10 may determine the second timing advance value TA-VAL-2 based on the so acquired satellite system information of the second satellite ASD-2.

As an example, in some embodiments, FIG. 5, the determining block 312 may comprise acquiring, by the terminal device 10, information associated with the second satellite ASD-2, e.g. satellite system information of the second satellite ASD-2, and determining the second timing advance value TA-VAL-2 based on the so acquired satellite system information of the second satellite ASD-2.

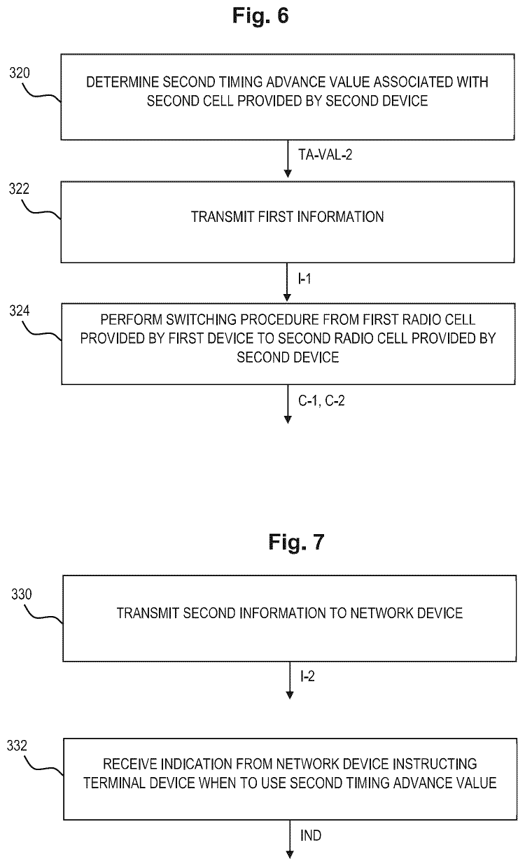

In some embodiments, FIG. 6, the instructions 106, when executed by the at least one processor 102, cause the terminal device 10 to perform 324 a switching procedure from the first radio cell C-1 provided by the first aerospace device ASD-1 to the second radio cell C-2 provided by the second aerospace device ASD-2, to determine 320 the second timing advance value TA-VAL-2 prior to performing 324 the switching procedure, and to transmit 322 the first information I-1 to the network device 20 associated at least with the first radio cell C-1 prior to performing 324 the switching procedure. In some embodiments, this enables to optimize a scheduling of resources for the terminal device 10 for the second radio cell C-2, which may, e.g., be used by the terminal device 10 after the switching procedure.

In some embodiments, FIG. 7, the instructions 106, when executed by the at least one processor 102, cause the terminal device 10 (FIG. 2) to perform at least one of: a) transmitting 330 (FIG. 7) second information I-2 to the network device 20, the second information I-2 indicating a point in time from which on the second timing advance value TA-VAL-2 may be used by the terminal device 10, and/or b) receiving 332 an indication IND from the network device 20 instructing the terminal device 10 when to use the second timing advance value TA-VAL-2. In some embodiments, this enables to provide further flexibility as to switching procedures associated with at least one aerospace device ASD-1, ASD-2. In this regard note that, while some embodiments, a switching between different aerospace device ASD-1, ASD-2 is contemplated, according to other embodiments, the principle according to the embodiments may also be applied to switching situations, wherein at least one aerospace device and at least one other device, such as e.g., terrestrial device, is involved.

In some embodiments, the transmission I-2 of the second information, see block 330 of FIG. 7, may also be combined with the transmission of the first information I-1, see, for example, block 302a of FIG. 3. Thus, in some embodiments, the terminal device 10 (FIG. 2) may provide a report to the network device 20, the report comprising both the first information I-1 and the second information I-2.

Further exemplary embodiments, FIG. 1B, relate to an apparatus 100′ for a terminal device 10 (FIG. 2), the apparatus 100′ comprising means 102′ for causing the terminal device 10 determine first to: 300 information I-1 characterizing a difference between a first timing advance value associated with a first radio cell C-1 that is at least temporarily provided to the terminal device by a first aerospace device and a second timing advance value associated with a second radio cell C-2 that is at least temporarily provided to the terminal device by a second aerospace device, and to transmit 302 the first information I-1 to a network device 20 associated at least with the first radio cell C-1.

In some embodiments, FIG. 1B, the means 102′ for causing the terminal device 10 to determine 300 the first information I-1 and to transmit 302 the first information I-1 may, e.g., comprise at least one processor 102 (FIG. 1A), and at least one memory 104 storing instructions 106 that, when executed by the at least one processor 102, cause the terminal 10 device to perform the aforementioned aspects 300, 302.

In some embodiments, FIG. 1B, the means 102′ for causing the terminal device 10 to determine 300 the first information I-1 and to transmit 302 the first information I-1 may, e.g., comprise circuitry configured to perform the aforementioned aspects 300, 302.

Further exemplary embodiments, FIG. 2, relate to a terminal device 10 comprising at least one apparatus 100, 100′ according to the embodiments. In some embodiments, the at least one apparatus 100, 100′ or its functionality, respectively, may be integrated into the terminal device 10. In some other embodiments, however, the at least one apparatus 100, 100′ or its functionality, respectively, is provided outside of the terminal device 10.

Further exemplary embodiments, FIG. 3, relate to a method for a terminal device 10, comprising: determining 300 first information I-1 characterizing a difference between a first timing advance value associated with a first radio cell that is at least temporarily provided to the terminal device by a first device, e.g. a first aerospace device, and a second timing advance value associated with a second radio cell that is at least temporarily provided to the terminal device by a second device, e.g., a second aerospace device, transmitting 302 the first information I-1 to a network device associated at least with the first radio cell.

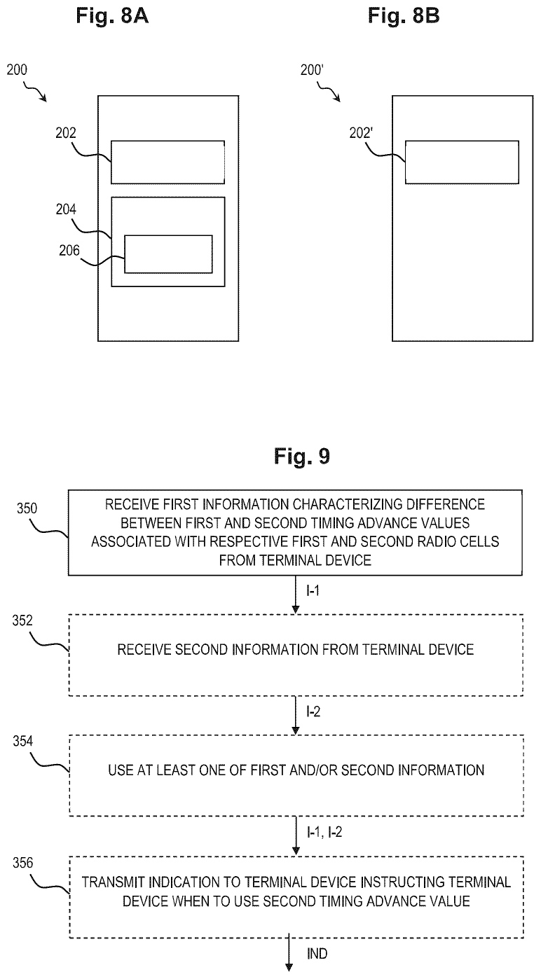

Further exemplary embodiments, FIG. 8A, 2, 9, relate to an apparatus 200 for a network device 20, the apparatus 200 comprising at least one processor 202, and at least one memory 204 storing instructions 206 that, when executed by the at least one processor 202, cause the network device 20 to: receive 350 (FIG. 9) from a terminal device 10 first information I-1 characterizing a difference TA-DIFF between a first timing advance value TA-VAL-1 associated with a first radio cell C-1 that is at least temporarily provided to the terminal device 10 by a first device ASD-1, e.g., a first aerospace device ASD-1, and a second timing advance value TA-VAL-2 associated with a second radio cell C-2 that is at least temporarily provided to the terminal device 10 by a second device ASD-2, e.g., a second aerospace device ASD-2.

In some embodiments, FIG. 9, the instructions 206, when executed by the at least one processor 202, cause the network device 20 to receive 352 second information I-2 indicating a point in time from which on the second timing advance value TA-VAL-2 may be used by the terminal device 10.

In some embodiments, FIG. 9, the instructions 206, when executed by the at least one processor 202, cause the network device 20 to use 354 at least one of the first information I-1 and/or the second information I-2, e.g. for aspects of scheduling, e.g. for the terminal device 10, e.g. associated with a switching between the aerospace devices ASD-1, ASD-2.

In some embodiments, FIG. 9, the instructions 206, when executed by the at least one processor 202, cause the network device 20 to transmit 356 an indication IND to the terminal device 10 instructing the terminal device 10 when to use the second timing advance value TA-VAL-2.

Further exemplary embodiments, FIG. 8B, relate to an apparatus 200′ for a network device 20, the apparatus 200′ comprising means 202′ for causing the network device 20 to: receive 350 (FIG. 9) from a terminal device 10 first information I-1 characterizing a difference between a first timing advance value associated with a first radio cell that is at least temporarily provided to the terminal device by a first device, e.g. aerospace device, and a second timing advance value associated with a second radio cell that is at least temporarily provided to the terminal device by a second device, e.g., aerospace device.

In some embodiments, FIG. 8B, the means 202′ for causing the network device 20 to receive 350 the first information I-1 may, e.g., comprise at least one processor 202 (FIG. 8A), and at least one memory 204 storing instructions 206 that, when executed by the at least one processor 202, cause the network device 20 to perform the aforementioned aspect(s) 350.

In some embodiments, FIG. 8B, the means 202′ for causing the network device 20 to receive 350 the first information I-1 may, e.g., comprise circuitry configured to perform the aforementioned aspect(s) 350.

Further exemplary embodiments, FIG. 2, relate to a network device 20 comprising at least one apparatus 200, 200′ according to the embodiments.

In some embodiments, the at least one apparatus 200, 200′ or its functionality, respectively, may be integrated into the network device 20. In some other embodiments, however, the at least one apparatus 200, 200′ or its functionality, respectively, is provided outside of the network device 20.

Further exemplary embodiments, FIG. 9, relate to a method for a network device 20, comprising: receiving 350 from a terminal device 10 first information I-1 characterizing a difference between a first timing advance value associated with a first radio cell that is at least temporarily provided to the terminal device by a first device, e.g. aerospace device, and a second timing advance value associated with a second radio cell that is at least temporarily provided to the terminal device by a second device, e.g., aerospace device.

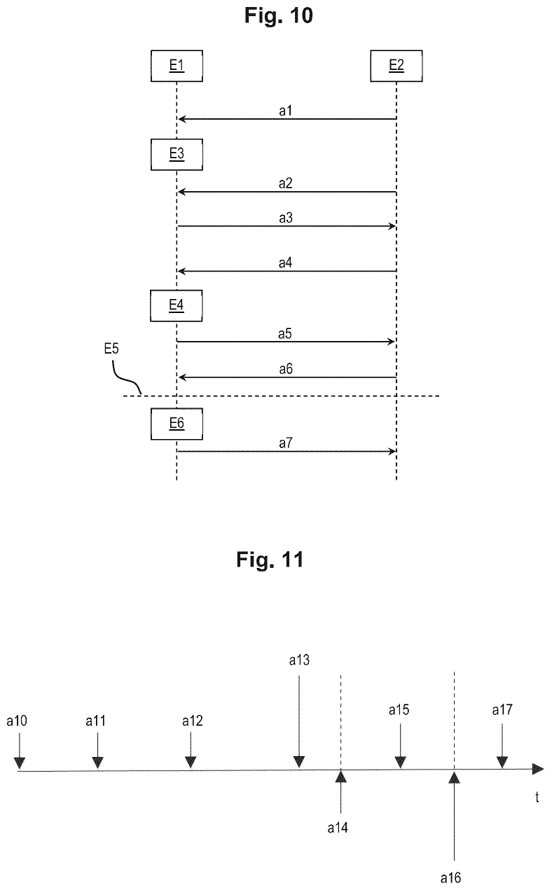

FIG. 10 schematically depicts a simplified signaling diagram according to some embodiments. Element E1 symbolizes a terminal device, e.g., similar or identical to the terminal device 10 of FIG. 2, and element E2 symbolizes a (currently) serving cell and/or a network device associated with the serving cell, e.g., similar or identical to the network device 20 of FIG. 2, wherein the currently serving cell is e.g. represented by the first radio cell C-1 of FIG. 2. Arrow a1 symbolizes information associated with a (for example currently serving) satellite system, e.g. the satellite ASD-1, block E3 symbolizes the terminal device E1 determining, e.g., estimating, the first timing advance value TA-VAL-1 associated with the first cell C-1 based on the received information a1. Arrow a2 symbolizes scheduling information transmitted by the serving cell E2 (e.g., cell C-1 of FIG. 2) to the terminal device 10, and arrow a3 symbolizes uplink (UL) data being transmitted by the terminal device 10 to the serving cell E2, e.g. via the links L2, L1 (FIG. 2). Arrow a4 symbolizes information associated with a target satellite system, e.g. the satellite ASD-2, wherein in future a switching procedure, e.g. satellite switching, by the terminal device 10 from the first satellite ASD-1 (e.g., “source satellite system”) to the second satellite ASD-2 (e.g., “target satellite system”), may be performed. Block E4 symbolizes the terminal device E1 determining, e.g., estimating, the second timing advance value TA-VAL-2 associated with the second cell C-2 based on the received information a4. Arrow a5 symbolizes the terminal device E1 transmitting the first information I-1 characterizing a difference between the first timing advance value TA-VAL-1 associated with the first (e.g., “source”) satellite ASD-1 and its radio cell C-1 and the second timing advance value TA-VAL-2 associated the second (e.g., “target”) satellite ASD-1 and its radio cell C-2 to the serving cell E2, e.g. gNB 20. Arrow a6 symbolizes scheduling information provided by the serving cell E2, e.g. gNB 20, to the terminal device E1, wherein, for example, the scheduling information a6 has been determined by the gNB 20 based on the first information a5, and wherein the scheduling information a6 relates, for example, at least to resources associated with the second cell C-2 of the target satellite. Dashed line E5 of FIG. 10 symbolizes a satellite switch, according to which the terminal device E1 switches from radio coverage of cell C-1 to radio coverage of cell C-2, thus switching from the first satellite ASD-1 to the second satellite ASD-2. Element E6 of FIG. 10 symbolizes the terminal device E1 applying a new, e.g. the second, timing advance value TA-VAL-2, e.g. as it is now served by the corresponding second cell C-2. Arrow a7 symbolizes the terminal device E1 transmitting uplink data to the serving cell, e.g., gNB E2, e.g., via the links L4, L3 (FIG. 2), e.g., using the second timing advance value TA-VAL-2.

In other words, in some embodiments, e.g., once the terminal device E1 acquires a4 system information of an upcoming (e.g., “target”) satellite ASD-2, the terminal device 10 estimates E4 the new, e.g., second, timing advance value TA-VAL-2, e.g., based on the new satellite's ephemeris and, optionally, based on a common timing advance. In some embodiments, e.g., after block E4, the terminal device transmits to the gNB E2 the target cell's (C-2) timing advance value (e.g., TA-VAL-2) and the currently-in-use TA (e.g., TA-VAL-1), e.g. in the form of the first information I-1 according to some embodiments. Based on the first information I-1, in some embodiments, the gNB 20 may schedule, e.g. re-schedule, downlink and/or uplink transmissions, e.g. considering at least one of: a) the first information I-1, and/or b) a point in time, where a service of the first cell C-1 is terminated, e.g. “t-Service”, e.g. due to a lack of radio coverage by the first cell C-1, and/or c) an interruption time (if applicable, in some embodiments), e.g., due to the satellite switching. In some embodiments, the terminal device receives the new scheduling data, see arrow a6 of FIG. 10, and starts transmitting accordingly, see arrow a7, thus e.g. avoiding duplicated transmissions and maximizing the cell resources.

In the following, further exemplary aspects and exemplary embodiments are disclosed with reference to the simplified time diagram of FIG. 11, which, in some embodiments, may be combined with each other and/or with at least one of the aforementioned aspects. Arrow a10 symbolizes the terminal device 10 acquiring a system information block, SIB, of the target cell C-2. Arrow a11 symbolizes the terminal device 10 estimating a new, e.g. the second, timing advance value TA-VAL-2, e.g. for use with the target cell C-2, e.g. based on the acquired SIB a10. After that, the terminal device reports the new, e.g. the second, timing advance value TA-VAL-2, e.g., in the form of the first information I-1, e.g., to the network device 20, see arrow a12 of FIG. 11. After receipt of the first information I-1, the network device 20 transmits scheduling information based on the first information I-1, see arrow a13. Arrow a14 of FIG. 11 indicates that the currently serving, e.g. first, cell C-1 (FIG. 2) stops coverage, e.g., characterizing “t-Service” as may e.g. be indicated in a system information block, e.g. SIB19, according to some planned and/or accepted standard. Arrow a15 symbolizes the terminal device 10 resuming a transmit operation, arrow a16 symbolizes the target cell C-2 starting coverage (e.g., “t-Start”), and arrow a16 symbolizes the terminal device 10 resuming receive operation, e.g. associated with the target cell C-2.

In the following, further exemplary aspects and exemplary embodiments are disclosed, which, in some embodiments, may be combined with each other and/or with at least one of the aforementioned aspects.

In some embodiments, the network device 20 schedules downlink (DL)/uplink (UL) transmission(s), e.g., for a given terminal device, e.g., UE 10, in the first, e.g., source cell C-1 (FIG. 1) provided by the first satellite ASD-1 (FIG. 2). In some embodiments, the UE 10, e.g. based on serving, e.g. source, cell system information-estimates the first timing advance value TA-VAL-1 and transmits UL radio frames accordingly.

In some embodiments, e.g., prior to t-Service (e.g., stop of coverage by the source cell), the UE 10 acquires new satellite system information for the new, e.g., second satellite ASD-2.

In some embodiments, e.g., prior to t-Service, the UE 10 estimates the new, e.g. second, timing advance value TA-VAL-2.

In some embodiments, upon the estimation of the second timing advance value TA-VAL-2, the UE 10 sends to the serving cell, e.g. gNB 20, the first information I-1, e.g. comprising old and new timing advance (e.g., “TA”) values TA-VAL-1, TA-VAL-2.

In some embodiments, an alternative approach is that the UE send the difference TA-DIFF between the old and new TA to the gNB 20.

In some embodiments, an alternative approach is that the UE send only the new TA (e.g., TA-VAL-2) to the gNB 20.

In some embodiments, the UE may apply the new TA TA-VAL-2 as of an epoch time in target cell's (C-2) SIB, but in some embodiments, the UE 10 can include in a report to the gNB 20 (the report e.g. comprising the first information I-1) a new TA's application time, so the gNB 20 may take that value into consideration.

In some embodiments, the gNB 20 takes the first information I-1, e.g., TA difference TA-DIFF, into account, e.g., to avoid that the UE 10 needs to schedule at the same time to the old cell C-1 and to the new cell C-2.

In some embodiments, the gNB 20 indicates to the UE 10 when the new TA (TA-VAL-2) needs to be taken into account.

In some embodiments, this indication can be done explicitly, e.g., with dedicated signaling, where one option according to some embodiments is to add the indication to a grant, e.g., indicating that for that particular grant the new TA (TA-VAL-2) needs to be taken into account by the UE 10.

In some other embodiments, the indication to the UE 10 when the new TA needs to be taken into account may also be signaled implicitly.

In some embodiments, e.g., prior to t-Service, the gNB 20 sends the new scheduling to the UE 10 based on the first information I-1, e.g. based on the new TA TA-VAL-2. In some embodiments, such scheduling may, e.g. only, be valid after t-Service (e.g., of the first, e.g. source, cell C-1), e.g., once the new satellite ASD-2 and thus the second, e.g. target, cell C-2 is available.

In some embodiments, e.g., based on t-Start, the UE 10 applies the new TA TA-VAL-2, and starts transmitting UL frames accordingly.

In some embodiments, the principle according to the embodiments enables the UE 10 to report an estimated TA for a target cell C-2 (FIG. 2) of a satellite switching procedure, the reporting e.g. being performed via serving cell C-1, so that the gNB 20 is aware of the new TA TA-VAL-2 associated with the target cell C-2, and, in some embodiments, the gNB 20 can e.g. optimize a scheduling accordingly.

In some embodiments, the principle according to the embodiments may be applied to target scenarios based on quasi-Earth fixed cells (EFC) deployments, where, for example, satellite switching occurs without layer 3 (L3) mobility.

In some embodiments, the principle according to the embodiments enables to at least temporarily attain one or more of the following advantages: reducing an interruption time during satellite switching, avoiding losing scheduling avoiding ambiguity in scheduling grants, opportunities, e.g., for configurations with unchanged PCI (physical cell identifier), wherein the PCI is not changed, e.g. between the cells C-1, C-2.

In some embodiments, the principle according to the embodiments enables to provide a scheduling optimization, where the UE 10 assists the network, e.g. gNB 20, e.g., with a timing advance estimation, e.g. for a target cell C-2, e.g. before a satellite switching, so the network can, for example, schedule DL/UL frames in target cell C-2 as close as possible to t-Service of the source cell C-1.

In some conventional approaches, a scheduling across a satellite switch is possible, so that a source cell can schedule in a target cell (i.e., source and target cell having a same PCI). In these conventional approaches, a problem can occur, e.g., when the TA of the target cell is larger than the TA of the current, e.g. source, cell, as a first scheduling in the target cell may need to happen at the same time as a last scheduling in the source cell. In other words, in these conventional approaches, this can lead to a UE needing to transmit in a same frame to each of the cells, which is not possible. In some embodiments, this problem can be solved by applying the principle according to the embodiments, thus avoiding ambiguity in scheduling grants.

Further exemplary embodiments, FIG. 2, relate to an aerospace device ASD-1 configured to receive from a terminal device 10, e.g., via a service link L2, first information I-1 characterizing a difference between a first timing advance value TA-VAL-1 associated with a first radio cell C-1 that is at least temporarily provided to the terminal device 10 by the first aerospace device ASD-1 and a second timing advance value TA-VAL-2 associated with a second radio cell C-2 that is at least temporarily provided to the terminal device 10 by a second aerospace device ASD-2, and to transmit the first information I-1, e.g., via a feeder link L1, to a, for example terrestrial, network device 20 associated at least with the first radio cell C-1.

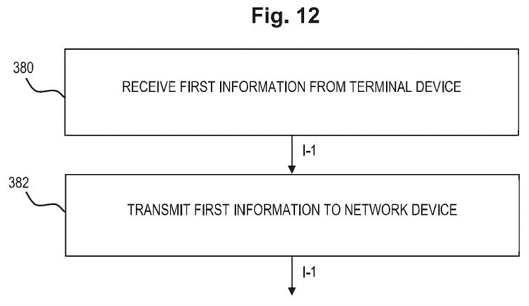

Further exemplary embodiments, FIG. 12, relate to a method for an aerospace device ASD-1, the method comprising: receiving 380, from a terminal device 10, e.g., via a service link L2, first information I-1 characterizing a difference between a first timing advance value TA-VAL-1 associated with a first radio cell C-1 that is at least temporarily provided to the terminal device 10 by the first aerospace device ASD-1 and a second timing advance value TA-VAL-2 associated with a second radio cell C-2 that is at least temporarily provided to the terminal device 10 by a second aerospace device ASD-2, and transmitting 382 the first information I-1, e.g., via a feeder link L1, to a, for example terrestrial, network device 20 associated at least with the first radio cell C-1.

Further exemplary embodiments, FIG. 2, relate to a communication system e.g. 1000, a non-terrestrial communication system, comprising at least one of: an apparatus 100, 100′, 200, 200′ according to the embodiments, and/or a terminal device 10 according to the embodiments, and/or a network device 20 according to the embodiments, and/or at least one aerospace device ASD-1 according to the embodiments.

In some embodiments, the communication system may e.g. be a non-terrestrial communication system adhering to and/or based on some accepted or planned standard, such as, e.g., a 5G or 6G standard.

1. An apparatus for a terminal device, the apparatus comprising:
at least one processor, and
at least one memory storing instructions that, when executed by the at least one processor, cause the terminal device to:
determine first information characterizing a difference between a first timing advance value associated with a first radio cell that is at least temporarily provided to the terminal device by a first device and a second timing advance value associated with a second radio cell that is at least temporarily provided to the terminal device by a second device, and
transmit the first information to a network device associated at least with the first radio cell.

2. The apparatus of claim 1, wherein the first information comprises at least one of: a) the first timing advance value and the second timing advance value, b) the difference between the first timing advance value and the second timing advance value.

3. The apparatus of claim 1, wherein each of the first device and the second device may be any one of the following: a) a spacecraft, for example a satellite, b) a high altitude platform system, HAPS, c) a terrestrial device.

4. The apparatus of claim 1, wherein the instructions, when executed by the at least one processor, cause the terminal device to perform at least one of: a) determining the first timing advance value, and/or b) determining the second timing advance value, and/or c) determining the first information.

5. The apparatus of claim 1, wherein the instructions, when executed by the at least one processor, cause the terminal device to perform a switching procedure from the first radio cell provided by the first device to the second radio cell provided by the second device, to determine the second timing advance value prior to performing the switching procedure, and to transmit the first information to the network device associated at least with the first radio cell prior to performing the switching procedure.

6. The apparatus of claim 1, wherein the instructions, when executed by the at least one processor, cause the terminal device to perform at least one of: a) transmitting second information to the network device, the second information indicating a point in time from which on the second timing advance value may be used by the terminal device, and/or b) receiving an indication from the network device instructing the terminal device when to use the second timing advance value.

7. A method for a terminal device, comprising:
determining first information characterizing a difference between a first timing advance value associated with a first radio cell that is at least temporarily provided to the terminal device by a first device and a second timing advance value associated with a second radio cell that is at least temporarily provided to the terminal device by a second device,
transmitting the first information to a network device associated at least with the first radio cell.

8. The method of claim 7, wherein the first information comprises at least one of: a) the first timing advance value and the second timing advance value, b) the difference between the first timing advance value and the second timing advance value.

9. The method of claim 7, wherein each of the first device and the second device may be any one of the following: a) a spacecraft, for example a satellite, b) a high altitude platform system, HAPS, c) a terrestrial device.

10. The method of claim 7, further comprising at least one of: a) determining the first timing advance value, and/or b) determining the second timing advance value, and/or c) determining the first information.

11. The method of claim 7, further comprising performing a switching procedure from the first radio cell provided by the first device to the second radio cell provided by the second device, determining the second timing advance value prior to performing the switching procedure, and transmitting the first information to the network device associated at least with the first radio cell prior to performing the switching procedure.

12. The method of claim 7, further comprising at least one of: a) transmitting second information to the network device, the second information indicating a point in time from which on the second timing advance value may be used by the terminal device, and/or b) receiving an indication from the network device instructing the terminal device when to use the second timing advance value.

13. An apparatus for a network device, the apparatus comprising:
at least one processor, and
at least one memory storing instructions that, when executed by the at least one processor, cause the network device to:
receive from a terminal device first information characterizing a difference between a timing advance value associated with a first radio cell that is at least temporarily provided to the terminal device by a first device and a second timing advance value associated with a second radio cell that is at least temporarily provided to the terminal device by a second device.

14. The apparatus of claim 13, wherein the instructions, when executed by the at least one processor, cause the network device to receive second information indicating a point in time from which on the second timing advance value may be used by the terminal device.

15. The apparatus of claim 13, wherein the instructions, when executed by the at least one processor, cause the network device to transmit an indication to the terminal device instructing the terminal device when to use the second timing advance value.
